(19) United States
(12) Patent Application Publication
(10) Pub. No.: US 2021/0156003 A1
(43) Pub. Date: May 27, 2021

(54) RECOVERY OF METALS FROM PYRITE

(71) Applicant: COBALT BLUE HOLDINGS LTD, Sydney, New South Wales (AU)

(72) Inventor: Andrew Robert TONG, North Turramurra, New South Wales (AU)

(21) Appl. No.: 16/633,140

(22) PCT Filed: Aug. 6, 2018
(86) PCT No.: PCT/AU2018/050817

§ 371 Date: Jan. 22, 2020

(30) Foreign Application Priority Data
Aug. 8, 2017 (AU) 2017903136

(51) Int. Cl. C22B 3/10; C01B 17/033; C22B 1/11; C22B 5/00

(52) U.S. Cl. CPC C22B 3/10; C22B 5/00; C22B 1/11; C01B 17/033

(57) ABSTRACT

A process is disclosed for the recovery of a metal from a pyrite-bearing material. The process comprises thermally decomposing the pyrite-bearing material so as to produce a material comprising pyrrhotite (FeS). The process also comprises leaching the material comprising pyrrhotite with an acid such that the iron in the pyrrhotite is oxidised to a +3 oxidation state, elemental sulphur is produced and the metal is released from the pyrite-bearing material.

### TECHNICAL FIELD

A process is disclosed for the recovery of metals which form part of a pyrite mineral lattice. The process can be applied to materials and minerals that comprise pyrite, including ores, concentrates, tailings, and other such materials or residues. The process may be used to recover in separate and useable forms sulphur, iron, and base or precious metals substituted into the pyrite lattice.

### BACKGROUND ART

Known pyrometallurgical processes for treating pyrite generally involve oxidation roasting which generates sulphur dioxide gas. The gas is typically converted into sulphuric acid for sale or disposal, while the residual calcines are leached for metal recovery. The iron component of the pyrite deports to the calcine leach residue for disposal. These processes incur significant costs to meet stringent environmental hurdles and, to be economically viable, further require a ready market for sulphuric acid.

Known hydrometallurgical processes for treating pyrite also generally oxidise the sulphur component into weak sulphuric acid which necessitates neutralisation and disposal of precipitated sulphates. The iron component is also typically lost to the leach residue for disposal.

WO 2014/038236 discloses a method for leaching gold from a gold ore containing pyrite. WO 2014/038236 discloses that pyrite can be converted into artificial pyrrhotite by thermal decomposition. The pyrrhotite is then leached at 45-95° C. for gold recovery, while generating a leach residue for disposal. WO 2014/038236 does not teach either the recovery of sulphur or iron as usable forms from the ore containing pyrite.

The above references to the background art do not constitute an admission that the art forms a part of the common general knowledge of a person of ordinary skill in the art. The above references are also not intended to limit the application of the process as disclosed herein.

### SUMMARY OF THE DISCLOSURE

A process is disclosed for the recovery from a pyrite-bearing material of a metal or metals which form part of the pyrite mineral lattice (i.e. base and/or precious metal(s) that are substituted into the lattice). The process may, for example, be employed to recover cobalt from pyrite-cobalt ores, although it should be understood that the process is not limited to this application. Advantageously, the process may produce other (e.g. saleable) products including hematite (Fe₂O₃) and sulphur.

The process as disclosed herein comprises (a) thermally decomposing the pyrite-bearing material so as to produce a material comprising pyrrhotite (FeS). The thermal decomposing of the pyrite-bearing material can take place in a thermal decomposition stage (a) in which the pyrite in the material is heated to decompose it into pyrrhotite and elemental sulphur, according to the generalised equation:

FeS₂₍ₛ₎=Fe₍ₓ₎S₍₂₋ₓ₎₍ₛ₎+xS_{(g)} (1)

The pyrrhotite produced by thermal decomposition stage (a) can be referred to as “artificial” pyrrhotite, in that it is artificially created by this stage rather than occurring in nature. Advantageously, the sulphur gas produced in the thermal decomposition stage (a) may be captured (e.g. condensed) and recovered as one of the (e.g. saleable) products of the present process, and as part of a “nil-waste-generated” metallurgical processing of pyrite.

The process as disclosed herein further comprises (b) leaching the material comprising pyrrhotite from (a) whereby the pyrrhotite is treated to simultaneously generate elemental sulphur and iron in a +3 oxidation state. The material comprising pyrrhotite may also comprise non-pyrrhotite minerals or gangue that can be on-forwarded to leaching stage (b) from thermal decomposition stage (a).

More specifically, the pyrrhotite can be leached with an acid (e.g. in a gaseous and/or aqueous liquid phase). During leaching the iron in the pyrrhotite is oxidised to the +3 oxidation state, elemental sulphur is produced, and the metal(s) are released from the pyrite-bearing material (i.e. liberated from the pyrite mineral lattice).

The base and/or precious metals from the pyrite-pyrrhotite lattice are thus able to be recovered from leaching stage (b). When the leaching employs an aqueous liquid and/or gaseous phase, the base or precious metals can be solubilised as part of the leaching stage (b). As set forth below, this can then enable downstream recovery of the metals by known methods including precipitation, cementation, electro-winning, solvent-extraction, ion-exchange, or other known recovery methods.

In one embodiment, oxygen may be added to the leaching stage (b) whereby the iron that is oxidised to the +3 oxidation state is then able to form hematite (Fe₂O₃). Here it may be seen that the leaching stage (b) comprises an acid-catalysed oxidation of pyrrhotite which is conducted at conditions that enable the formation of hematite and sulphur, and which releases base and/or precious metals from the pyrite-pyrrhotite lattice. The relevant equations may be represented as follows:

2FeS₍ₛ₎+1.50_{2(g)}+6H⁺=2Fe³⁺+2S_{(g)}+3H₂O (2)

2Fe³⁺+3H₂O=Fe₂O₃+6H⁺ (3)

2FeS₍ₛ₎+1.50_{2(g)}=Fe₂O₃₍ₛ₎+2S₍ₛ₎ (4)

In one embodiment, and as set forth herein, the leaching stage (b) typically comprises conditions that favour the formation of hematite (Fe₂O₃) as opposed to other iron oxides, hydroxides, sulphates, or chlorides. In the above equations, by producing elemental sulphur, the consumption of oxygen will be much lower than prior art processes in which sulphur dioxide and/or sulphuric acid are produced. Advantageously, the hematite and sulphur produced in the leaching stage (b) may be separated and recovered as another of the (e.g. saleable) products of the present process, and as another part of the “nil-waste-generated” metallurgical processing of pyrite. In this regard, the Fe₂O₃ and elemental sulphur solids may be recovered and passed to sulphur and iron oxide recovery stages respectively, as set forth below.

As set forth above, in leaching stage (b), the material comprising pyrrhotite may be mixed with an acidic aqueous solution, so that the metal (e.g. base and/or precious metal(s)) in the pyrite-bearing material may be released into the solution. Advantageously, the metal(s) released in the leaching stage (b) may be separated and recovered as further (e.g. saleable) product of the present process, and as a further part of the “nil-waste-generated” metallurgical processing of pyrite.

In this regard, the solution from leaching stage (b) may be passed to a metal recovery stage in which the metal is separated from the solution and the solution is then recycled back to the leaching stage (b). Prior to being recycled into the leaching stage (b), the acidity of the solution may be regenerated by the addition of an acid (e.g. such as hydrochloric or sulphuric acid).

In one embodiment, the pH of the acidic aqueous solution in leaching stage (b) may be controlled to be in the range of −1 to 3.5. This pH range can promote the precipitation of iron in the +3 oxidation state as Fe₂O₃. In this regard, it is noted that an optimal pH range for Fe³⁺ precipitation is 0.5-2.5. However, when there is no copper present in the acidic aqueous solution, the upper end of this range may move to 3 or potentially even to 3.5. Further, whilst it is noted that Fe³⁺ precipitation as Fe₂O₃ can occur above 3.5 (i.e. up to about pH 6), as the solution pH increases the solubility of Fe³⁺ decreases significantly, with the solubility of Fe³⁺ at a pH above 3.5 being <0.1-0.2 g/L. Thus, the ability for the Fe³⁺ to participate in the leaching of the pyrrhotite drops significantly when the pH is greater than around 3.5.

In one embodiment, the temperature of the acidic aqueous solution in leaching stage (b) may be controlled to be somewhere in the range of around 95-220° C.

For example, when the acid in leaching stage (b) comprises an acidic aqueous halide solution (e.g. hydrochloric acid), the solution temperature may be controlled to be somewhere in the range of around 95-150° C. More optimally, the solution temperature may be controlled to be somewhere in the range of around 130-140° C. Thus, in the case of an acidic aqueous halide solution, and as set forth below, the leaching stage (b) may be operated at atmospheric pressure (e.g. it may not require the use of an autoclave, or autoclave-like conditions). However, for increased leaching kinetics, leaching stage (b) may instead be operated at elevated pressures—e.g. between 1-20 ATM. Here, an autoclave, or an autoclave-like apparatus, may be employed

In another example, when the acid in leaching stage (b) comprises an acidic aqueous sulphate solution (e.g. sulphuric acid), the solution temperature may be controlled to be somewhere in the range of around 150-220° C. More optimally, the solution temperature may be controlled to be somewhere in the range of around 190-210° C. Thus, in the case of an acidic aqueous sulphate solution, and as set forth below, the leaching stage (b) may be operated at elevated pressures (i.e. requiring the use of an autoclave, or autoclave-like conditions). In such case, leaching stage (b) may be operated at elevated pressures—e.g. between 1-20 ATM.

In either example, the residence time of the material passed to the leaching stage (b) may range from 0.1-24 hours. Optimally, leaching conditions can be employed whereby the residence time of material in the leaching stage may be around 1-2 hours.

In one embodiment, when the solution in leaching stage (b) comprises an aqueous halide solution, the halide may have a concentration in the range 1-10 moles per litre of solution. As a part of optimising the conditions in leaching stage (b), the halide may have a concentration of around 5 moles per litre.

In one embodiment, when the solution in leaching stage (b) comprises an aqueous halide solution, the solution in leaching stage (b) may comprise a metal halide solution. For example, the metal halide solution may comprise one or more of: NaCl, NaBr, CaCl₂, and CaBr₂. The metal of the halide solution may also comprise magnesium, copper, etc. as well as Fe³⁺ from the oxidised pyrrhotite. The magnesium, copper, etc. metals may already be present in the pyrite-bearing material, or may be added.

In one embodiment, the residual solids produced in leaching stage (b) (i.e. in a leach slurry that exits leaching stage (b)) may be recovered and passed to a sulphur recovery stage. In one embodiment, the leach slurry exiting leaching stage (b) may be filtered. Thus, the sulphur recovery stage may then be conducted on the filter cake.

The sulphur recovery stage may comprise a separation stage in which the elemental sulphur is separated from the iron oxide. The separation stage may employ known techniques for recovery of sulphur such as, but not limited to, flotation, sizing screens, gravity, distillation, and melting or remelting. When distillation of the sulphur from the filter product is employed, the distillation operating temperature range may be around 250-550° C., more typically around 450-500° C.

The recovered elemental sulphur from the sulphur separation stage may be combined with the elemental sulphur recovered from the thermal decomposition stage (a). The combined elemental sulphur may be sold in bulk and/or reused in the process.

After the sulphur separation stage, the remaining solids (including the precipitated iron oxide) may be recovered by filtration, whereas the filtrate solution may be recycled to leaching stage (b).

In one embodiment, the residual solids from the sulphur separation stage (e.g. the filter product) may be passed to an iron oxide recovery stage. The iron oxide recovery stage may comprise a thermal treatment stage in which remaining elemental sulphur is roasted out of the iron oxide. The resultant sulphur-free iron oxide can be recovered and may be saleable (e.g. it can be used as a substitute for natural iron ore in industrial processes).

In one embodiment, the residual iron oxide may be prepared for the thermal sulphur removal treatment by forming it into pellets, lumps or similar. Binders and other reagents may be added into the pellets, lumps or similar to promote the de-sulphurisation process.

In one embodiment, the operating temperature range for the desulphurisation of the iron oxide may be around 300-1400° C., more typically around 1250-1350° C. The optimum temperature can depend on the properties of the residual gangue material.

In one embodiment, the recovery of sulphur in the thermal treatment stage may generate energy, on account of cooling, or burning/roasting, which can be utilised for this stage, or which may be used in other parts of the process.

In one embodiment, the sulphur separation stage and the iron oxide recovery stage may be combined into a single unit operation, whereupon the elemental sulphur may be collected simultaneously with the beneficiation of the iron oxide.

In one embodiment, the sulphur dioxide that may be produced by roasting of the iron oxide may be captured in a wet scrubber. The captured sulphur dioxide may be recycled to leaching stage (b) and can participate in leaching of non-pyrrhotite minerals or gangue which may be forwarded to leaching stage (b) from thermal decomposition stage (a).

Thus, embodiments of the process as disclosed herein are able to bring together: (a) thermal decomposition of the pyrite into artificial pyrrhotite (which is an energy consuming step) and elemental sulphur; (b) oxidation of the pyrrhotite into iron oxide and elemental sulphur, while simultaneously leaching the base or precious metals for downstream recovery; recovery of the elemental sulphur from the leach residue for sale; and de-sulphurising of the iron oxide for sale. As a result, the pyrite mineral may be treated to produce useable and saleable forms of sulphur and iron while simultaneously recovering the base or precious metals associated with the pyrite. This is in contrast to known processes where the sulphur and iron are not recovered, and thus the present disclosed process may be applied to pyrite materials that comprise nil or small amounts of base or precious metals, because it still produces useable and saleable forms of sulphur and iron. In this regard, the present disclosed process may render, as economic, material that would otherwise be deemed uneconomic.

In one embodiment, the thermal decomposition of pyrite in stage (a) may be operated under: inert conditions (e.g. employing inert gases such as nitrogen, argon, etc.); reducing conditions (e.g. by employing reducing gases such as carbon dioxide); or under other gas conditions in which available oxygen is restricted to prevent oxidation of the sulphur atoms into sulphur dioxides, and thereby to favour artificial pyrrhotite production.

In one embodiment, the operating temperature of the thermal decomposition stage (a) may be between 450° C. and 900° C. More specifically, the operating temperature of stage (a) may be between 600° C. and 800° C. Whilst known thermal decomposition stages have employed higher temperatures to transform the artificial pyrrhotite solids into a matte, it has been observed that this is not desirable for the disclosed process.

The thermal decomposition stage (a) can be referred to as a pyrolysis stage. Pyrolysis may occur at temperatures >450° C. and typically above 600° C. The pyrolysis may be conducted in an oxygen-free environment (e.g. in an inert gas such as nitrogen, argon, etc.; or in a reducing (e.g. CO₂) gas atmosphere, etc.) so as to prevent oxidation of the sulphur gas produced.

In one embodiment, as part of the thermal decomposition stage (a), the elemental sulphur gas may be separated from the pyrrhotite (e.g. by a carrier gas) and condensed in a separate vessel for direct recovery as elemental sulphur prills or the like. One advantage of this process embodiment is that the condensation of the gaseous elemental sulphur into solid sulphur generates energy which can be utilised elsewhere in the process.

In one embodiment, the residence time of the solids in the thermal decomposition stage (a) may be between 1 minute and 240 minutes. More optimally, the residence time may be controlled to be between 45 and 125 minutes.

In one embodiment, air may be processed by known methods to produce nitrogen for use in the thermal decomposition stage (a) and to produce oxygen for use in the leaching stage (b). The simultaneous consumption of both nitrogen and oxygen provides a level of efficiency which would not be available if the unit operations for stages (a) and (b) were operated in isolation (e.g. stage (a) without stage (b) or vice versa).

In one embodiment, the calcine (i.e. the material comprising the artificial pyrrhotite) that is produced in thermal decomposition stage (a) may be upgraded by physical techniques such as magnetic separation, particle size separation, or gravity separation, so as to reduce the amounts of non-pyrrhotite gangue that is advanced to the leaching stage (b).

As set forth above, the conditions in leaching stage (b) may be selected to promote the simultaneous oxidation of the artificial pyrrhotite, and precipitation of hematite. As set forth above in equations (2) and (3), the oxidation reaction consumes acid and oxygen, whereas the precipitation reaction generates acid. Advantageously, by running both chemical reactions simultaneously, the disclosed process can offer an elegant efficiency, which can stand in stark contrast to known pyrite leaching processes, the latter which consume large amounts of oxygen and generate large amounts of acid for neutralisation/disposal.

As set forth above, the aqueous solution employed in leaching stage (b) may be an aqueous halide solution. The aqueous halide solution may comprise mixtures of metal halides, where the metal may be sodium, calcium, magnesium, iron, copper, etc. Such aqueous halide solutions have been observed to promote the formation of hematite in preference to jarosites, the latter which readily form when using aqueous sulphate solutions at temperatures <150° C.

In one embodiment, a neutralising agent, such as a metal alkali, may be added to leaching stage (b) to balance any incoming acid from the sulphur dioxide recovered and recycled from the iron oxide thermal treatment (e.g. roasting) stage, or to balance other acid added to leach stage (b) or generated in-situ in leach stage (b). This neutralising agent may be selected to cause additional iron oxide to be precipitated. For example, the neutralising agent may comprise one or more of: limestone, lime, sodium carbonate, sodium hydroxide, magnesium carbonate, magnesium hydroxide, magnesium oxide, etc.

As set forth above, the temperature of the solution in leaching stage (b) may be controlled to promote hematite precipitation. When using aqueous halide solutions, temperatures greater than 95° C. can be used to promote hematite formation over akaganeite (an iron oxychloride). An optimal temperature range may be between 110-135° C. When using aqueous sulphate solutions, temperatures higher than 150° C. are used to promote hematite formation over basic ferric sulphate. An optimal temperature range may be between 190-210° C.

Additionally, in leaching stage (b) operating at temperatures above the melting point of sulphur (˜115° C.) may be employed to promote dispersion of elemental sulphur from the residual un-leached particles or from the newly formed iron oxide.

As set forth above, the leaching stage (b) may be operated at elevated pressures to achieve the desired temperature values (e.g. by employing an autoclave). As set forth above, the operating pressures may range between 1-20 ATM. However, it should be noted that aqueous halide brine solutions have high boiling points, and therefore the leaching stage (b) may be operated at elevated temperatures (>100° C.) without a need to increase pressure above atmospheric levels. Thus, for aqueous halide brine solutions, a standard leaching vessel may be employed, and an autoclave or other higher-pressure vessel need not be employed.

In one embodiment, the solution pH in leaching stage (b) may be less than 7. Optimally, the solution pH in leaching stage (b) may be controlled to be in the range of <3.5, as set forth above. The range and values of pH has been observed to be inter-dependent on the operating temperature and pressure, and is selected accordingly.

In one embodiment, the elemental sulphur formed during leaching stage (b) may be dispersed from the residual solids by the addition of dispersants to the slurry.

In one embodiment, the base and/or precious metals solubilised in leaching stage (b) may be recovered from a so-called “pregnant” solution by precipitation, sulphidisation, cementation, adsorption onto resins or carbon, solvent extraction, electro-winning, or other known techniques.

In one embodiment, the pyrite material that is passed to the thermal decomposition stage (a) may first be prepared by flotation, gravity, leaching, or other separation stages for other target metals. Examples may include froth flotation of the pyrite (or sulphides) from an ore, to thereby prepare a concentrate that is ready for treatment in the disclosed process.

In a variation of the process, other metal sulphides that may be present along with the pyrite, may also thermally decompose in stage (a), or may leach in stage (b).

The extent of reaction of these ancillary metal sulphides can be a function of mineralogy, temperature, available acid, oxidation conditions, etc. Thus, the disclosed process can be operated or incorporated within a multi-metal refinery or processing plant. In such cases, the range of pyrite content of the material being treated in a thermal decomposition stage of such a multi-metal refinery may range between 5-100% of the mass, and typically can be between 70-90 wt. %.

In one embodiment, each of the thermal decomposition stage (a), leaching stage (b), sulphur recovery, and iron oxide desulphurisation and recovery, may be provided as circuits. Further, these circuits may be integrated. In addition, each stage may each comprise multiple reaction/reactor stages. Employing multiple reaction/reactor stages can allow for better control of each of the individual stages, generally resulting in improved yields, and better targeting of specific impurities or to-be-recovered metals.

The multiple reaction stages may each be operated in a co-current configuration. A co-current configuration can allow for better integration of the flow circuits with minimal or simple solid/liquid/gas separation equipment required.

However, in some applications of the process, a counter-current configuration may be adopted for the multiple reactions/reactors per stage. For example, a counter-current configuration may be required where the specific feed materials are complex and the counter-current configuration can assist and/or improve the efficiency of the process.

### BRIEF DESCRIPTION OF THE DRAWINGS

Notwithstanding any other forms which may fall within the scope of the process as defined in the Summary, specific embodiments will now be described, by way of example only, with reference to the Examples and the accompanying drawings in which:

FIG. 1 shows a block diagram for an embodiment of the process comprising a number of circuits that are integrated to process pyrite and produce elemental sulphur and iron oxide, and recover base or precious metals that are part of the pyrite mineral lattice;

FIG. 2 shows a block diagram for an embodiment of the process comprising a number of circuits that are integrated to process pyrite and produce elemental sulphur and iron oxide, and recover cobalt metal that forms a part of the pyrite mineral lattice;

FIG. 3 which shows the X-ray diffraction profiles at various temperatures for a pyrite concentrate which is thermally treated under an argon atmosphere.

### DETAILED DESCRIPTION OF SPECIFIC EMBODIMENTS

In the following detailed description, reference is made to the accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

### Flowsheet Descriptions

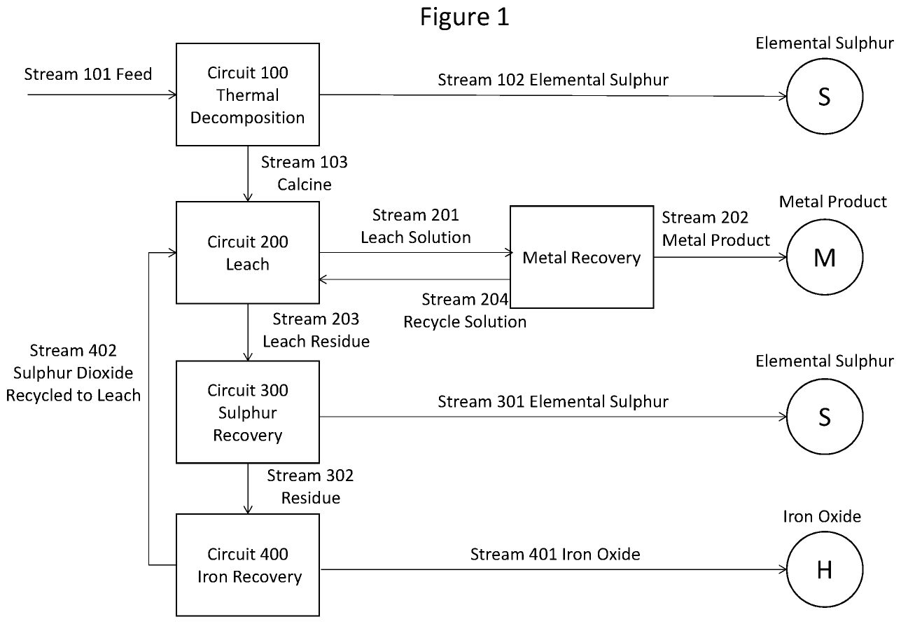

FIG. 1 shows a process flowsheet in block diagrammatic form. The flowsheet illustrates a generalised embodiment for the treatment of pyrite bearing material to produce useable forms of sulphur, iron and contained base or precious metals.

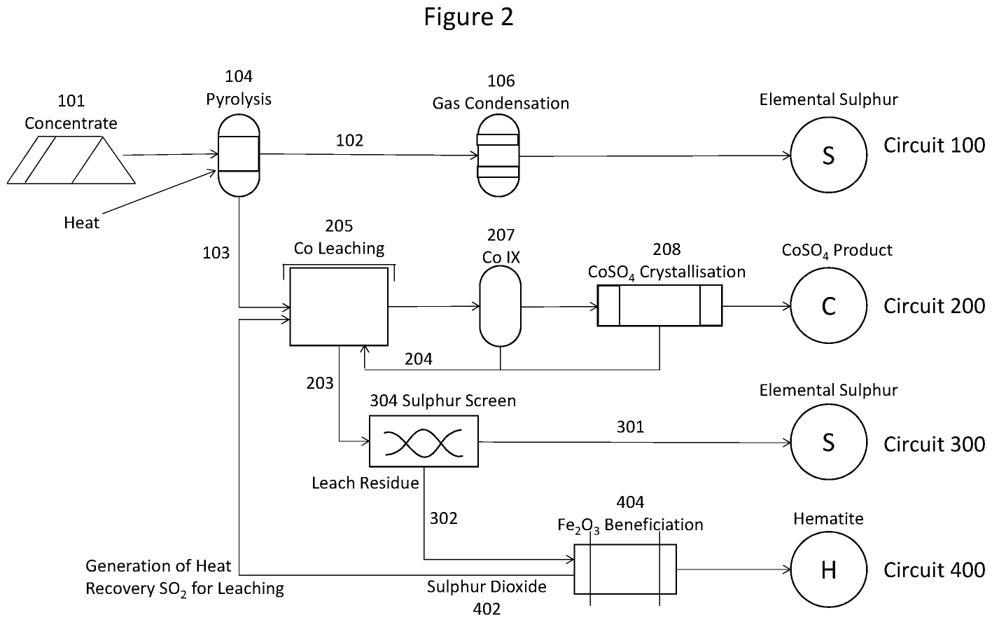

FIG. 2 also shows a process flowsheet in block diagrammatic form. The flowsheet illustrates an embodiment for the treatment of pyrite bearing material to produce useable forms of sulphur, iron and cobalt contained in the pyrite-bearing material.

Each of the flowsheets of FIGS. 1 and 2 depicts a sequential process whereby thermal decomposition, followed by leaching and precipitation, are integrated into a consolidated process.

Each flowsheet comprises four main integrated circuits: a thermal treatment circuit 100, followed by leaching the calcine produced in circuit 100 in a leaching circuit 200. The leach residue is processed in sulphur circuit 300 for recovery of elemental sulphur, and the remaining leach residue is beneficiated in iron oxide circuit 400 to produce useable iron oxide.

Additional circuits for recovery of other base or precious metals can be included, such as further precipitation stages, solvent extraction, and/or ion-exchange resins, as may be the case for recovering leached metals which were leached either simultaneously or in separate stages to the leaching of the calcine from circuit 200.

Hereafter, reference will be made to each of FIGS. 1 and 2, with specific features of either flowsheet being highlighted as required.

### Thermal Treatment (Decomposition)

Usually the pyrite-bearing material that is passed to the thermal treatment circuit 100 is prepared by flotation, gravity, leaching, or other separation stages for other target metals. For example, the pyrite may be concentrated by froth flotation of the pyrite (or sulphides) from an ore. This prepares a concentrate 101 that is now ready to be thermally treated in circuit 100.

More specifically, the pyrite-bearing material is thermally decomposed in circuit 100. The pyrite feed 101 is heated in an inert atmosphere (e.g. nitrogen and/or argon) to prevent oxidation of the mineral by interaction with oxygen. The flowsheet of FIG. 2 depicts thermal decomposition as a pyrolysis stage 104.

In the thermal treatment circuit 100 the pyrite decomposes into pyrrhotite (which has no specific iron to sulphur ratio, but which is commonly simplified as Fe₇ S₈) and elemental sulphur as shown in the following reaction 1:

FeS₂₍ₛ₎→FeS₂₋ₓ₍ₛ₎+xS_{(g)} Rn 1

The temperature must be greater than 450° C. for the reaction to proceed, although an optimal temperature is in the range of around 600-750° C. The reaction duration can be in the range of 1 minute to 240 minutes, and typically takes place over 60 to 90 minutes. The off-gas (stream 102) containing the elemental sulphur is cooled to condense the sulphur S (e.g. in a gas condenser 106), and to ultimately recover the sulphur S in a solid form.

Next, the calcine (stream 103) is forwarded to the leach circuit 200, where the artificial pyrrhotite is leached while simultaneously precipitating iron oxide. The flowsheet of FIG. 2 depicts leaching occurring in a leaching reactor 205.

Leaching can take place in a gas phase, optionally in an aqueous gas phase. However, for many pyrite-bearing materials typically the leach circuit 200 employs an aqueous liquid phase for ease of handling and unit operations.

In this latter case, the contained base and/or precious metals are solubilised into the liquor media. The sulphur component of the pyrrhotite is oxidised to elemental sulphur, and is not oxidised to sulphuric acid (as would be the case for prior art processes which leach the sulphur component of pyrite). As a consequence, the net reaction of the disclosed process requires a small consumption of oxygen compared to the leaching of pyrite. Further, there is no generation of free acid requiring neutralisation, as is the case when leaching pyrite. The reactions, when an aqueous halide solution is employed, are as follows:

Leaching 2FeS₍ₛ₎+1.5O_{2(g)}+6HCl→2FeCl₃+2S_{(g)}+3H₂O Rn 2

Precipitation FeCl₃+3H₂O→Fe₂O₃+6HCl Rn 3

Overall 2FeS₍ₛ₎+1.5O_{2(g)}→Fe₂O₃₍ₛ₎+2S₍ₛ₎ Rn 4

{In the above reactions FeS is used for simplicity in the nomenclature, however, here it should be understood that FeS stands for FeₓS₍₂₋ₓ₎}

In the process as depicted, the concentration of the halide solution can be in the range of 1-10 moles per litre of solution, and is optimally around 5 moles per litre. A typical halide solution employed is sodium-halide (although the solution can contain mixtures of magnesium or calcium halides). Copper may also be present in the feed pyrite-bearing material or added as copper salts (see below).

The temperature of the leach and precipitation step/stage can be controlled to be in the range of 95-150° C., and is optimally controlled to be around 130-140° C. This optimal temperature range promotes the simultaneous formation of hematite and liquefies the elemental sulphur. Upon cooling, the sulphur freezes and can be separated by physical or chemical processes in sulphur circuit 300.

The pH of the leach and precipitation step can be controlled to be <7, with the optimal range being somewhere between −1 and 3.5.

The net reactions consume oxygen for the oxidation of the pyrrhotite. This can be supplied by sparging air or oxygen directly into a leach and precipitation reactor. Alternatively, the leaching solution can contain ferric cations which oxidise the pyrrhotite. The ferric ions can be produced by oxidising ferrous ions inside or outside of the main leach reactor. Similarly, other oxidation couples can be employed, such as cupric/cuprous. The reaction for ferrous/ferric oxidation is as follows:

Oxidation FeCl₂+HCl+0.25O_{2(g)}→FeCl₃+0.5H₂O Rn 5

The resultant leach solution (stream 201) containing base and/or precious metals is forwarded to metal recovery unit operations such as precipitation, electrowinning, ion-exchange, solvent extraction, etc. The flowsheet of FIG. 2 depicts the metal recovery unit operations occurring as cobalt ion-exchange 207 followed by a cobalt sulphate crystallisation stage 208, to produce a cobalt sulphate product C.

In most instances, a return stream 204 of solution will be recycled back to the leach circuit 200 in a closed-loop fashion to minimise emissions to the environment.

Thirdly, the leach residue stream 203 from circuit 200 is forwarded to sulphur circuit 300 for recovery of the elemental sulphur. The elemental sulphur can be separated from the iron oxide in the leach residue by any of the known processes, including, but not limited to, particle size separation, gravity techniques, froth flotation, distillation, melting or remelting. The flowsheet of FIG. 2 depicts sulphur recovery occurring as a sulphur screening stage 304, which produces a stream 301 representing a further sulphur product S.

Fourthly, the remaining iron oxide (stream 302) from circuit 300 is forwarded to an iron oxide beneficiation circuit 400. In this circuit the iron oxide is thermally treated to remove any remaining sulphur. The flowsheet of FIG. 2 depicts iron oxide recovery occurring in an Fe₂O₃ beneficiation furnace 404, which produces a hematite product H.

An oxidising atmosphere is used in the furnace to promote the oxidation of the sulphur to sulphur dioxide. The furnace temperature is in the range of 300-1400° C., more typically around 1250-1350° C. The sulphur dioxide that is produced can be captured in a wet scrubber and recycled to the leach circuit 200 as a weak sulphurous acid stream 402.

Each of the circuits 100, 200, 300, and 400 can comprise one or more recycle streams to allow for control of solids residence time to improve yield/recovery. Each recycle stream can be from a given reactor stage to a previous reactor stage; a so-called “internal” recycle (for example the slurry from one reactor is recycled back to a previous reactor). Alternatively or additionally, each recycle stream can be from a separation stage (for example off-gas from one circuit to another circuit) to a given reactor stage; a so-called “external” recycle.

### Thermal Decomposition Circuit 100 (in Detail)

The thermal decomposition circuit 100 usually comprises a furnace connected to a feed hopper. An inert atmosphere is provided by blanketing the solids with an inert gas (e.g. nitrogen, argon, etc.). The feed material is heated to a temperature in the range of 450° C. to 900° C., optimally 600° C. to 800° C. The off-gas from the furnace is collected, and cooled, with elemental sulphur subsequently condensing and freezing. A particulate filter can be used to minimise any carry-over of solids into the off-gas stream. Once the elemental sulphur is collected, the inert gas can be recycled to the furnace. The calcine (solids product containing pyrrhotite) is discharged from the furnace, and typically cooled to below 100° C. while still under an inert atmosphere. This step is to prevent any unwanted oxidation reactions taking place. The number of ancillary items of process equipment in addition to the furnace, and the furnace design, will vary depending on the throughput, and feed material characteristics such as moisture content and particle size.

### Leach Circuit 200 (in Detail)

In leach circuit 200, the calcine material (stream 103) is mixed with an acidic aqueous halide solution. The slurry density range is typically from 0.5-60% w/w, and is often adjusted to minimise process plant equipment size. The oxidation-reduction potential is typically maintained at >450 mV (versus Ag/AgCl) to ensure oxidation of the pyrrhotite. More specifically, the oxidation-potential is sufficient to oxidise any ferrous cations into ferric cations for subsequent precipitation of iron oxide.

Additional, subsequent reactors can employ oxidative leaching conditions to target other minerals once the artificial pyrrhotite has been leached (e.g. in a first or early stages of leach circuit 200).

In leach circuit 200, leaching is carried out at a temperature in the range of 95-220° C., optimally at around 130-140° C. for aqueous halide solutions, and typically for a residence time of 0.1-24 hours under atmospheric pressure or elevated pressures of 1-20 ATM. Often the artificial pyrrhotite leaches rapidly, and a residence time of <2 hours (i.e. around 1-2 hours) can be sufficient.

The precipitated elemental sulphur and iron oxide, along with the un-leached gangue minerals are separated as stream 203, while the solution advances as stream 201 to a metal recovery circuit. The brine is recycled as stream 204 back to the start of leach circuit 200 once the target metals have been recovered. The pH of the recycled solution stream is adjusted to be <7, and preferably between −1 and 3.5, before being mixed with incoming calcine material from stream 103. Usually stream 203 is filtered to recover the brine solution for return to the start of leach circuit 200, before the solids advance to the sulphur recovery circuit 300.

### Sulphur Recovery Circuit 300 (in Detail)

The leach residue produced in leach circuit 200 contains elemental sulphur. The sulphur recovery circuit 300 usually comprises a series of vessels where the elemental sulphur is separated using particle size separation (e.g. cyclones), gravity separation (e.g. concentrators, spirals, tables), froth flotation (e.g. flotation cells), a melting or remelting stage, etc. The optimum method is selected based on the physical characteristics of the elemental sulphur, such as particle size. The residual leach residue, after elemental sulphur is recovered, is forwarded to the iron oxide recovery circuit 400.

The collected sulphur often contains some trapped leach residue, and thus a secondary circuit can be utilised to improve the purity of the sulphur. Non-limiting examples include distillation, chemical dissolution and re-precipitation, etc.

### Iron Oxide Recovery Circuit 400 (in Detail)

The iron oxide recovery circuit 400 usually comprises a furnace where the iron oxide is thermally treated. The treatment is typically under oxidising conditions designed to reduce the amount of sulphur in the iron oxide. Elemental sulphur is oxidised to sulphur dioxide, which is captured and directed to the leach circuit 200. If a wet scrubber is employed, then the sulphur dioxide gas can be solubilised as sulphurous acid. The temperature of the treatment furnace is in the range of 300-1400° C., and is optimally operated at 1200-1300° C. Often, the iron oxide is first pelletised or converted from fines into lumps prior to thermal treatment. The number of ancillary items of process equipment in addition to the furnace, and the furnace design, will vary depending on the throughput, and feed material characteristics such as moisture content and particle size.

### Solids-Liquid Separation

Appropriate flocculants and coagulants can be added to the slurries throughout the process to improve the efficiency of the solid-liquid separation stages. Typically, each separation stage comprises a thickener and a filter, but alternatives can be a counter-current decantation stage, a single stage filter, or similar equipment. The thickening stage can make use of high rate thickeners, low rate thickeners, clarifiers and similar devices for solid-liquid separation. The filtration stage can make use of pressure filters, pan filters, belt filters, press filters, centrifuge filters and similar devices for solid-liquid separation.

Typically, each slurry is first sent to a thickener; with the resulting underflow slurry then forwarded to a filter for recovery of solids. The overflow can comprise process solution, or may be further filtered.

Washing of the solids during recovery is employed to minimise any losses of process solutions and salts from the circuit. Fresh water is required for washing, and this is evaporated in the process reactors in the leach circuits. The resulting water vapour is discharged through the off-gas scrubber system or condensed and recycled as fresh wash waters.

### Off-Gas Handling and Scrubbing

Off-gases are transferred from the various process reactors. The thermal decomposition circuit 100 off-gas contains elemental sulphur and is condensed for recovery of solid or liquid sulphur. The leach circuit 200 off-gas contains water and acidic vapours which is collected in a scrubber for water recovery and recovery of the acid. The iron oxide circuit 400 off-gas contains sulphur dioxide, which is collected in a scrubber and directed back to the leach circuit 200.

### EXAMPLES

Non-limiting Examples of various stages (circuits) of the process for treating pyrite to recover useable forms of sulphur, iron, and base or precious metals (such as cobalt) contained in the pyrite mineral lattice will now be described.

### Example 1: Determination of Temperature for Thermal Decomposition of Pyrite

A sulphide concentrate sample was shown to contain a pyrite mineral where cobalt had substituted into the crystal lattice for iron atoms. No other cobalt bearing minerals were detected in the sample by QEMSCAN analysis, scanning electron microscopy, or x-ray diffraction.

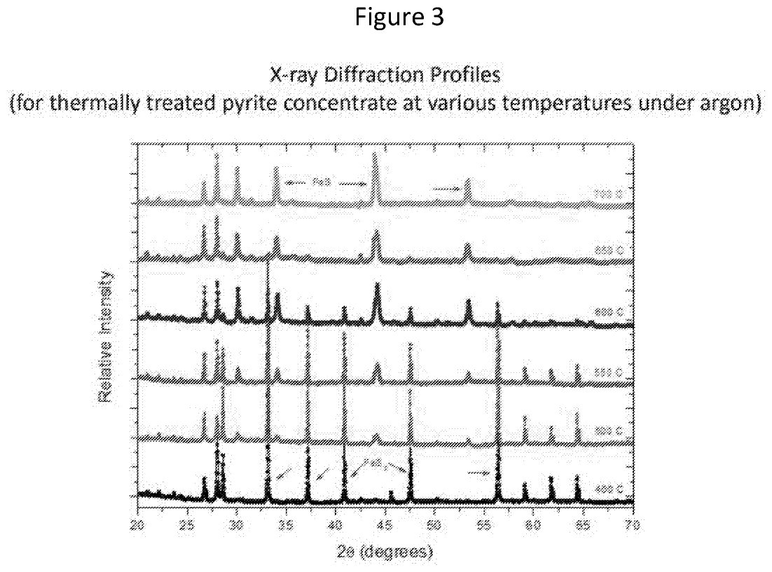

Samples of the cobalt-pyrite concentrate were determined to contain 90% pyrite, 7% albite, 3% silica, and <1% miscellaneous gangue. The samples were treated under argon for 2 hours. A range of temperatures were used, from 450° C. to 700° C. The ratio of pyrite to pyrrhotite was measured by x-ray diffraction. At temperatures between 450° C. and 600° C., the decomposition was partially complete. Above 650° C. all of the pyrite had transformed to pyrrhotite. The x-ray diffraction profiles for thermally treated pyrite concentrate at various temperatures under argon are shown in FIG. 3.

As expected, the main phase transition was the decomposition of pyrite into pyrrhotite. The transition began at 500° C. and was complete by 650° C. In contrast to a prior art roasting reaction with oxygen, the decomposition of pyrite into pyrrhotite was observed to be a thermal phase transition.

### Example 2: Thermal Decomposition of Pyrite to Produce Elemental Sulphur

A 500 g sample of the same cobalt-pyrite concentrate used in Example 1, was thermally decomposed at 650° C. for 2 hours under nitrogen. The off-gas was cooled, resulting in the freezing of gases into a solid residue. The composition of the residue from the off-gas was measured by x-ray diffraction, and shown to be 97.3% elemental sulphur, and 2.7% pyrite. The pyrite in the off-gas residue was a result of particulate carryover from the furnace reactor, and was able to be minimised by passing the off-gas through a filter. In total, 41% of the sulphur present in the pyrite was evolved from the concentrate by thermal decomposition.

### Example 3: Effect of Residence Time on Thermal Decomposition of Pyrite to Pyrrhotite

A second batch of cobalt-pyrite concentrate was obtained, and used in a series of tests to illustrate the effect of time on the thermal decomposition of pyrite into pyrrhotite. Three, 2 kg samples of the concentrate were heated to 750° C., with the residence time varied from 15 minutes, 30 minutes, and 45 minutes. An inert atmosphere was obtained by purging the reaction vessel with 99% nitrogen. The resulting calcine product was analysed by x-ray diffraction. The results are given in Table 1, and show that the pyrite was progressively converted into pyrrhotite with increasing residence time.

TABLE 1
Mineral Content of Calcine Product

| Mineral | Units | Start | 15 minutes | 30 minutes | 45 minutes |
|---|---|---|---|---|---|
| Mass | g | 2000 | 1809 | 1739 | 1690 |
| Pyrite | % | 66.8 | 25.9 | 10.7 | 1.9 |
| Pyrrhotite | % | 5.6 | 46.1 | 55.4 | 67 |
| Albite | % | 10.6 | 12.6 | 14.1 | 10.7 |
| Quartz | % | 9.7 | 9.6 | 11.5 | 10.7 |

The off-gas from the kiln, was directed to a chamber, for recovery of elemental sulphur by condensation and freezing (the chamber was cooled externally by ambient air flow). The sulphur was analysed by elemental analysis, and was shown to contain >99% elemental sulphur.

### Example 4: Leaching Calcine from Thermal Decomposition in Sulphate Media

The calcine from Example 2 was analysed by x-ray diffraction and shown to contain 81.6% pyrrhotite, 9.6% albite, 3.6% silica, and 5.2% miscellaneous gangue (<0.1% pyrite). The major elements were 50.4% iron, 33.2% sulphur, and 0.49% cobalt. A subsample of the calcine was leached in sulphuric acid at 130° C. in an autoclave for 2 hours. The pressure was 4 bars, and oxygen was sparged into the reactor at an over pressure of 2 bars. The resulting leach solubilised >99% of the cobalt, and oxidised >99% of the sulphur in the pyrrhotite to elemental sulphur. Only 33% of the iron in the pyrrhotite was precipitated as hematite, with the other 67% precipitating as jarosite. The formation of jarosite was able to be prevented by using higher autoclave temperatures, e.g. temperatures in the range of 180° C. to 200° C.

### Example 5: Leaching Calcine from Thermal Decomposition in Chloride Media

A further 28 kg of cobalt-pyrite concentrate was thermally decomposed to prepare calcines for leach experiments. Each batch was between 2-3 kg, and the temperature was varied between 700° C.-750° C., with the residence time being varied between 15 minutes, 30 minutes, 45 minutes and 60 minutes.

The resulting calcines were blended into various feed samples, to obtain different pyrite to pyrrhotite ratios. A calcine containing 55% pyrrhotite and 18% pyrite was selected for leaching, to illustrate the difference in leachability of pyrrhotite versus pyrite.

A 250 g subsample of the calcine was leached in an autoclave with a solution containing 150 g/L NaCl and 150 g/L CaCl₂, and 5 g/L FeCl₃. The temperature was 130° C., and the starting solution pH was adjusted to 0.5 using HCl. The natural internal pressure from heating the slurry to 130° C. in the autoclave was 3 ATM, and oxygen was sparged in the reactor with an overpressure of 7 ATM, bringing the total pressure to 10 ATM. The leach proceeded until no further oxygen was consumed, with this occurring at approximately 60 minutes.

The resulting leach solubilised 73.6% of the cobalt, and produced a leach residue containing predominantly elemental sulphur and hematite. The mineral content was measured using x-ray diffraction, and is shown in Table 2. In contrast to Example 4, where a sulphate leaching media was used, no jarosites were identified in the leach residue produced from a chloride leaching media. The remaining pyrite content, indicated that this mineral was not leached under the conditions, and hence the leach conditions were selective for pyrrhotite. The cobalt extraction was limited to the destruction of pyrrhotite, with the remaining 26.4% of the cobalt being hosted in the unreacted pyrite fraction.

TABLE 2
Mineral Content of Leach Residue

| Mineral | Units | Feed | Leach Residue |
|---|---|---|---|
| Mass | g | 253 | 279 |
| Pyrite | % | 18.1 | 12.92 |
| Pyrrhotite | % | 53.6 | 0.15 |
| Hematite | % | Not present | 46.02 |
| Goethite | % | Not present | 1.36 |
| Elemental Sulphur | % | Not present | 21.95 |
| anhydrite | % | Not present | 0.66 |

The resulting leach solution contained 920 ppm cobalt, and was forwarded to a separate metal recovery circuit using ion-exchange and crystallisation to produce cobalt sulphate.

### Example 6: Leaching of Pyrrhotite Calcine from Thermal Decomposition Using Chloride Media

A separate subsample of calcine produced in Example 5, was leached using the same conditions described in Example 5. In contrast to Example 5, this subsample contained 0.1 wt. % pyrite and 92.6 wt. % pyrrhotite. The resulting cobalt extraction was 97.5%, as indicated in the metal content of the feed and leach residue shown in Table 3.

TABLE 3
Metal Content of Leach Residue

| Mineral | Units | Feed | Leach Residue |
|---|---|---|---|
| Mass | g | 1000 | 1272 |
| Fe | % | 55.4 | 42.3 |
| S | % | 37.9 | 25.1 |
| Co | % | 0.51 | 0.01 |
| SiO₂ | % | 3.56 | 2.93 |
| Ca | % | Not present | 0.84 |

The resulting leach residue was processed to separate the elemental sulphur from the precipitated hematite using known methods. This example demonstrated that excellent recovery of cobalt could be achieved with a high conversion of the pyrite into pyrrhotite.

Whilst a number of specific process embodiments have been described, it should be appreciated that the process may be embodied in other forms.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the process as disclosed herein.

1. A process for treating a pyrite-bearing material to enable the recovery therefrom of a metal, elemental sulphur and Fe₂O₃, the process comprising:
(a) thermally decomposing the pyrite-bearing material so as to produce a material comprising pyrrhotite (FeS) and a separate elemental sulphur material;
(b) leaching the material comprising pyrrhotite from (a) with an acid, the leaching conditions being controlled such that the metal is released from the material comprising pyrrhotite, the iron in the pyrrhotite is oxidised to Fe₂O₃, and the sulphur in the pyrrhotite is oxidised to elemental sulphur in a form that is separate from the metal and that is separable from the Fe₂O₃.

2. A process as claimed in claim 1 wherein oxygen is added to the leaching stage (b) to form the Fe₂O₃, with the Fe₂O₃ being removed from the leaching stage (b) along with elemental sulphur solids.

3. A process as claimed in claim 1, wherein in leaching stage (b) the material comprising pyrrhotite is leached with an acid by mixing it with an acidic aqueous solution, wherein the metal is released into the solution to be recovered therefrom.

4. A process as claimed in claim 3, wherein solution pH in leaching stage (b) is controlled to be in the range of −1 to 3.5 to promote the precipitation of iron as Fe₂O₃.

5. A process as claimed in claim 3, wherein solution temperature in leaching stage (b) is controlled to be in the range of around 95-220° C.

6. A process as claimed in claim 1, wherein when the acid comprises an acidic aqueous halide solution, the solution temperature in leaching stage (b) is controlled to be in the range of around 95-150° C., and is optimally in the range of around 130-140° C.

7. A process as claimed in claim 1, wherein leaching stage (b) is operated at atmospheric pressure.

8. A process as claimed in claim 1, wherein when the acid comprises an acidic aqueous sulphate solution, the solution temperature in leaching stage (b) is controlled to be in the range of around 150-220° C., and is optimally in the range of around 190-210° C.

9. A process as claimed in claim 1, wherein leaching stage (b) is operated at elevated pressures between 1-20 ATM.

10. A process as claimed in claim 1, wherein the residence time of the material passed to leaching stage (b) ranges from 0.1-24 hours, and is optimally around 1-2 hours.

11. A process as claimed in claim 2, wherein the Fe₂O₃ and elemental sulphur solids are recovered and passed to sulphur and iron oxide recovery stages respectively.

12. A process as claimed in claim 3, further comprising passing the solution from (b) to a metal recovery stage in which the metal is separated from the solution and the solution is then recycled back to the leaching stage (b).

13. A process as claimed in claim 12 wherein the acidity of the solution is regenerated by the addition of an acid, such as hydrochloric or sulphuric acid, prior to the solution being recycled to the leaching stage (b).

14. A process as claimed in claim 3, wherein the solution in leaching stage (b) comprises an aqueous halide solution having a concentration in the range 1-10 moles per litre of solution, optimally around 5 moles per litre.

15. A process as claimed in claim 3, wherein the solution in leaching stage (b) comprises a metal halide solution that comprises one or more of: NaCl, NaBr, CaCl₂, and CaBr₂.

16. A process as claimed in claim 1, wherein the elemental sulphur produced in step (a) is recovered and combined with the elemental sulphur produced in leaching step (b).
